(19) United States
(12) Patent Application Publication
(10) Pub. No.: US 2016/0039343 A1
(43) Pub. Date: Feb. 11, 2016

(54) SYSTEM AND METHOD FOR DETERMINING A DISTANCE BETWEEN SENSORS ON A VEHICLE

(71) Applicant: Bendix Commercial Vehicle Systems LLC, Elyria, OH (US)

(72) Inventors: Karl H. Jones, Fullerton, CA (US); Andreas U. Kuehnle, Villa Park, CA (US)

(21) Appl. No.: 14/455,606

(22) Filed: Aug. 8, 2014

(51) Int. Cl. B60R 1/00; G01B 11/14; H04N 7/18

(52) U.S. Cl. CPC B60R 1/00; H04N 7/183; G01B 11/14

(57) ABSTRACT

A camera system on a vehicle includes an electronic control unit, a base sensor, on a first portion of the vehicle, and a remote sensor on a second portion of the vehicle. The base sensor and the remote sensor communicate with the electronic control unit. The electronic control unit determines a distance between the base sensor and the remote sensor based on respective signals received from the base sensor and the remote sensor representing respective measurements of a vertical physical quantity by the base sensor and the remote sensor.

### BACKGROUND

The present invention relates to camera systems for vehicles. It finds particular application in conjunction with associating cameras for an articulated heavy vehicle and will be described with particular reference thereto. It will be appreciated, however, that the invention is also amenable to other applications.

Maneuvering heavy vehicles (e.g., straight trucks, articulated trucks, busses, etc.) can be challenging. For example, maneuvering such heavy vehicles in the reverse direction can be particularly difficult. To aid a vehicle operator in such circumstances, cameras have begun to be incorporated on vehicles. For example, these cameras are typically placed on the sides and back of a vehicle. The operator uses a display to view areas around the vehicle captured by the cameras to assist in maneuvering the vehicle.

Although cameras used on passenger cars may be wired to a display via a cable, wired configurations are not practical on heavy vehicles. More specifically, because the length of a heavy vehicle is almost always longer than that of a passenger car, the length of cable required for heavy vehicles is often prohibitive. In addition, articulated trucks typically include a tractor that can easily couple to, and decouple from, different trailers. Therefore, when other tractors and trailers are nearby, it is necessary to associate the correct sensor(s), which are on respective trailer cameras, with the correct tractor. In some situations, when more than one trailer is towed by a single tractor in, for example, a road train configuration, multiple trailers (e.g., trailer cameras) must be associated with the proper tractor.

The present invention provides a new and improved apparatus and method which addresses the above-referenced problems.

### SUMMARY

In one embodiment, a camera system on a vehicle includes an electronic control unit, a base sensor on a first portion of the vehicle, and a remote sensor on a second portion of the vehicle. The base sensor and the remote sensor communicate with the electronic control unit. The electronic control unit determines a distance between the base sensor and the remote sensor based on respective signals received from the base sensor and the remote sensor representing respective measurements of a vertical physical quantity by the base sensor and the remote sensor.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic representation of a heavy vehicle including a camera system in accordance with one embodiment of an apparatus illustrating principles of the present invention;

FIG. 2 is an exemplary methodology of associating sensors and cameras in a camera systems in accordance with one embodiment illustrating principles of the present invention;

FIG. 3 is an exemplary methodology of associating sensors in accordance with one embodiment illustrating principles of the present invention;

FIGS. 4a and 4b illustrate graphical representations of acceleration in accordance with one embodiment of an apparatus illustrating principles of the present invention;

FIG. 5 is an exemplary methodology of associating sensors in accordance with another embodiment illustrating principles of the present invention;

FIG. 6 is an exemplary methodology of determining distance between two sensors in accordance with one embodiment illustrating principles of the present invention; and

FIG. 7 illustrates graphical representations of acceleration in accordance with one embodiment of an apparatus illustrating principles of the present invention.

### DETAILED DESCRIPTION OF ILLUSTRATED EMBODIMENT

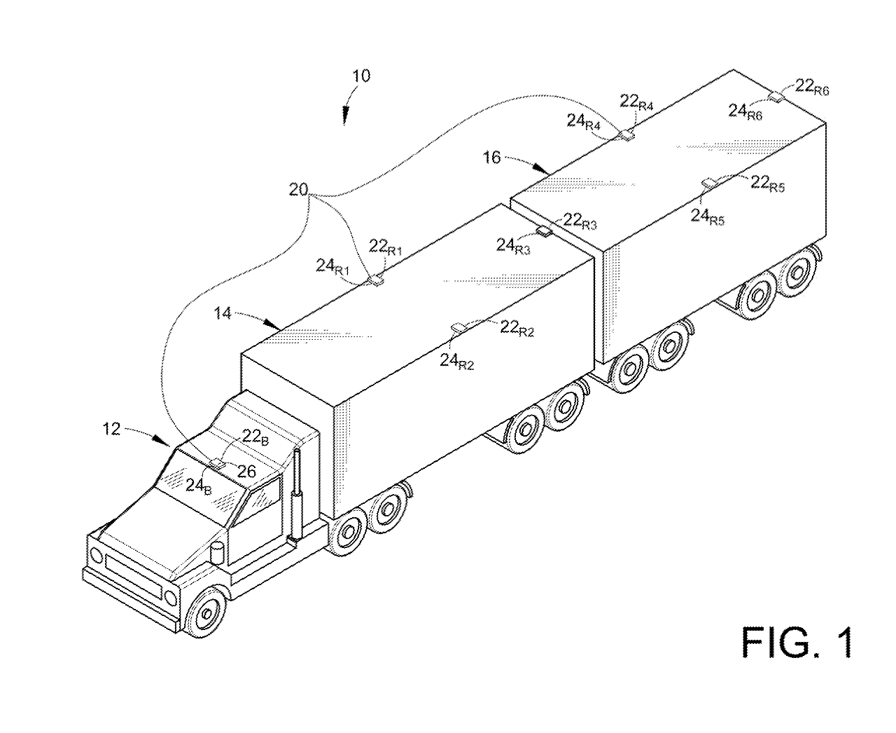

With reference to FIG. 1, a perspective view of a heavy vehicle 10 such as, for example, an articulated truck in accordance with one embodiment of the present invention. The articulated vehicle 10 includes a first portion 12, a second portion 14, and a third portion 16. In the illustrated embodiment, the first portion 12 of the articulated vehicle 10 is a towing portion (e.g., a tractor), the second portion 14 of the articulated vehicle 10 is a first towed portion (e.g., a first trailer), and the third portion 16 of the articulated vehicle 10 is a second towed portion (e.g., a second trailer). Although two (2) towed portions (e.g., two (2) trailers) are illustrated, it is to be understood that any number of towed portions (e.g., trailers) are contemplated. For example, embodiments of the present invention may be practiced on heavy vehicles including only one (1) towed portion, more than two (2) towed portions, or even no towed portions (e.g., a straight truck).

A camera system 20 is included on the vehicle 10. The camera system 20 includes a plurality of cameras 22 around the vehicle 10. For example, the first portion 12 (e.g., tractor) of the vehicle 10 may optionally include a base camera 22_{B} (e.g., a base camera). The second portion 14 (e.g., first trailer) of the vehicle 10 may include three (3) remote cameras 22_{R1,R2,R3} (e.g., remote cameras), and the third portion 16 (e.g., second trailer) of the vehicle 10 may include three (3) remote cameras 22_{R4,R5,R6} (e.g., remote cameras). The first and second trailers 14, 16 both include one camera 22_{R1,R2,R4,R5} on each side and one camera 22_{R3},_{R6} on the rear. All of the cameras 22_{B,R1-R6} (collectively 22) together may be used to create a view substantially surrounding (e.g., a Surround View) the vehicle 10 as part of the camera system 20.

Each of the cameras 22_{B,R1-R6} includes a respective associated sensor 24_{B,R1-R6} (collectively 24). In one embodiment, it is contemplated that the sensors 24 are incorporated into (e.g., integral with) the respective cameras 22. Alternatively, the sensors 24 are separate from the respective cameras 22. Regardless of whether the sensors 24 are integral with, or separate from, the respective cameras 22, each of the sensors 24 electrically communicates with the respective camera 22. Although the base camera 22_{B} is noted above as optional, the base sensor 24_{B} is included. If the camera 22_{B} is included, the sensor 24_{B} electrically communicates with the camera 22_{B}. Similarly, the sensor 24_{R1} electrically communicates with the camera 22_{R1}, the sensor 24_{R2} electrically communicates with the camera 22_{R2}, the sensor 24_{R3} electrically communicates with the camera 22_{R3}, the sensor 24_{R4} electrically communicates with the camera 22_{R4}, the sensor 24_{R5} electrically communicates with the camera 22_{R5}, and the sensor 24_{R6} electrically communicates with the camera 22_{R6}. Like the cameras 22, any of the sensors 24_{B} on the tractor 12 are referred to as base sensors, while any of the sensors 24_{R1-R6} on any of the trailers 14, 16 are referred to as remote sensors.

The camera system 20 also includes a electronic control unit (ECU) 26. In the illustrated embodiment, the ECU 26 is located on the tractor portion 12 of the vehicle 10. It is contemplated that the ECU 26 may be one that already typically exists on heavy vehicles such as, for example, an antilock braking system (ABS) ECU, an electronic stability program ECU, electronic braking system (EBS) ECU, etc., or, alternatively, a separate ECU for the camera system 20. In one embodiment, the base sensor 24_{B} and the optional base camera 22_{B} are part of (e.g., integral with), or substantially adjacent to, the ECU 26.

Each of the sensors 24 communicates with the ECU 26. Although it is possible that each of the sensors 24 communicates with the ECU 26 via a wired connection, it is contemplated that at least the remote sensors 24_{R1-R6} on the trailers 14, 16 wirelessly communicate with the ECU 26 via radio-frequency (RF) signals. Any of the base sensors 24_{B} may also communicate with the ECU 26 via a wired connection or wirelessly via RF signals. Whether the individual sensors 24 communicate with the ECU 26 via a wired or wireless connection, the sensors 24 are said to electrically communicate with the ECU 26.

As discussed above, articulated trucks, such as the vehicle 10, typically include a tractor 12 that can easily couple to, and decouple from, different trailers 14, 16.

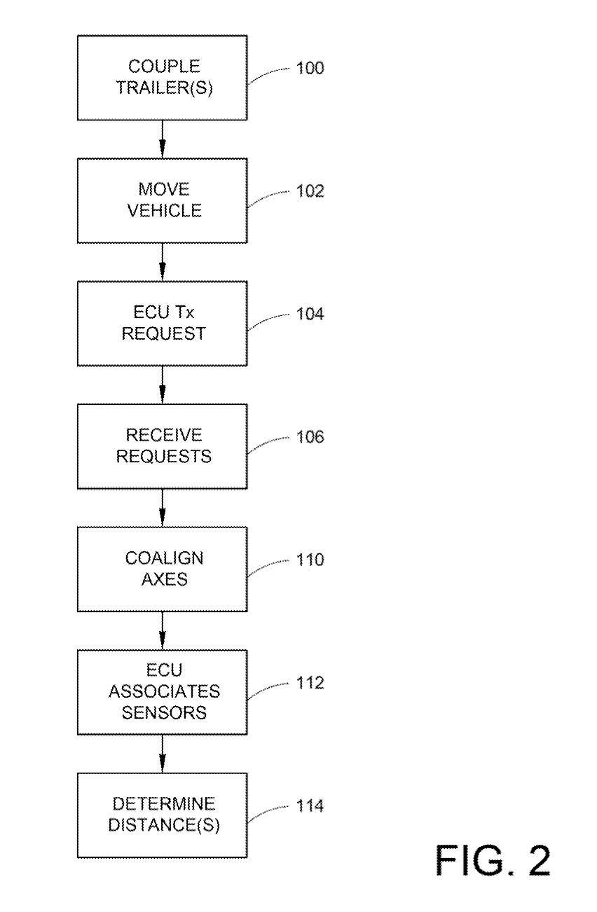

FIG. 2 illustrates an exemplary methodology for associating the remote sensors 24_{R1-R6} (and their associated cameras 22_{R1-R6}) with the ECU 26 and/or the base sensor 24_{B}. Since the base sensor 24_{B} (and its associated camera 22_{B}) and the ECU 26 are both on the tractor 12, it is assumed the base sensor 24_{B} (and its associated camera 22_{B}) were previously associated with the ECU 26. Therefore, once any of the remote sensors 24_{R1-R6} is associated with the ECU 26, the same remote sensor(s) 24_{R1-R6} are associated with the base sensor 24_{B}. As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1 and 2, at least one of the trailers 14, 16 is coupled to the tractor 12 in a step 100. In the illustrated embodiment, the first trailer 14 is coupled to the tractor 12, and the second trailer 16 is coupled to the first trailer 14. Therefore, the tractor 12, the first trailer 14, and the second trailer 16 form a road train configuration.

After the at least one of the trailers 14, 16 is coupled to the tractor 12, the vehicle 10 begins to move in a step 102. Once the vehicle 10 begins moving, the ECU 26 transmits a request signal, in a step 104. The request signal is intended to cause each of the sensors 24 to begin transmitting data signals. The request signal is received by each of the sensors 24 in a step 106.

Each of the sensors 24 responds similarly after receiving the request signal from the ECU 26. Therefore, a general description regarding the sensors 24 is provided. Once a sensor 24 receives the request signal, the sensor 24 optionally confirms, in a step 110, the horizontal axes (x,y) and vertical axis (z) are collinear with the other sensors. More specifically, in the step 110, the sensor confirms the vertical axis (z) is aligned with a gravity vector. Once the vertical axis (z) is aligned with a gravity vector, the horizontal axes (x,y) are assumed to be aligned, since the horizontal axes (x,y) are orthogonal to each other and the vertical axis (z). Optionally, the magnitude of the acceleration orthogonal to the direction of gravity may be taken as the total (e.g., not downward) acceleration acting on each sensor.

As discussed in more detail below, the remote sensors 24_{R1-R6} (and their associated cameras 22_{R1-R6}) are associated with the ECU 26, in a step 112. In other words, the ECU 26 associates the remote sensors 24_{R1-R6} with the tractor 12 of the vehicle 10. Furthermore, respective distances between the base sensor 24_{B} and each of the remote sensors 24_{R1-R6} are determined in a step 114.

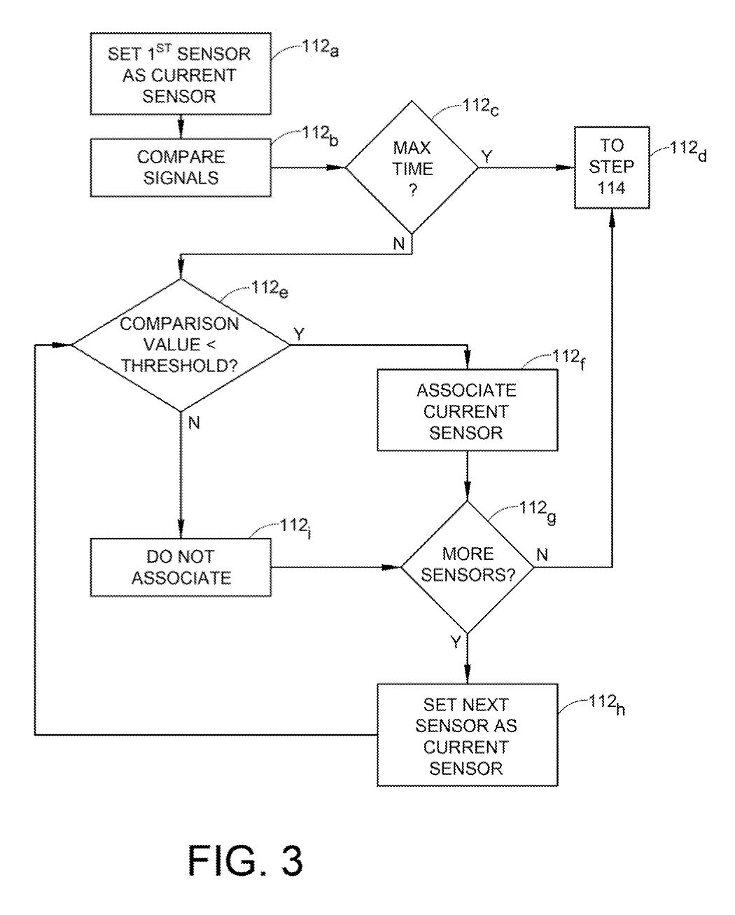

FIG. 3 illustrates a first embodiment of an exemplary methodology of the step 112 for associating the remote sensors 24_{R1-R6} (and their associated cameras 22_{R1-R6}) (see FIG. 1) with the ECU 26 (see FIG. 1) (e.g., with the tractor 12 of the vehicle 10). As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

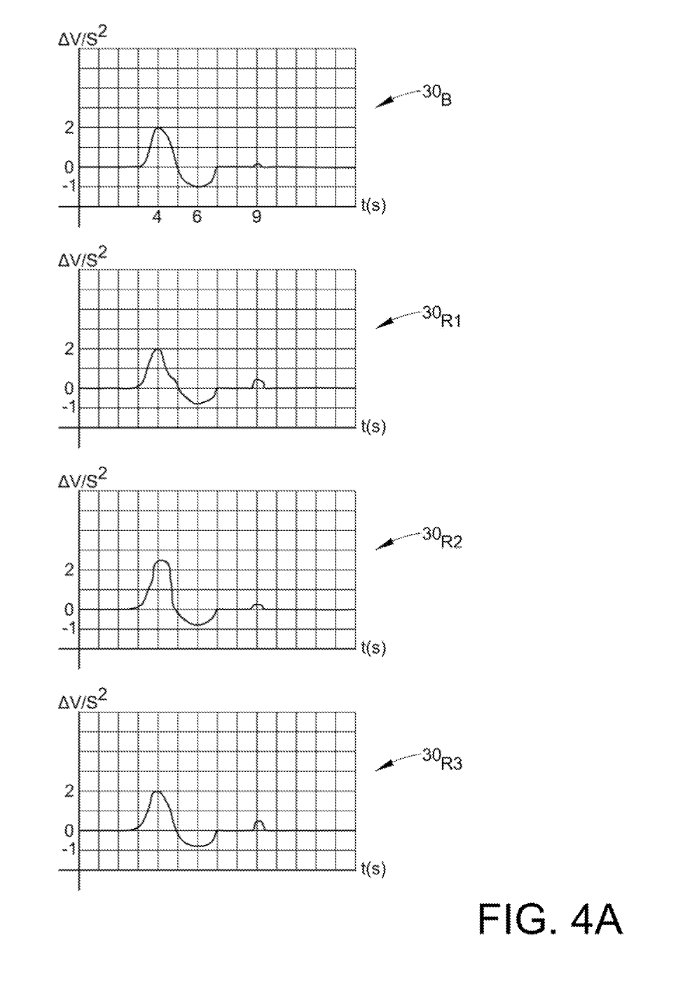

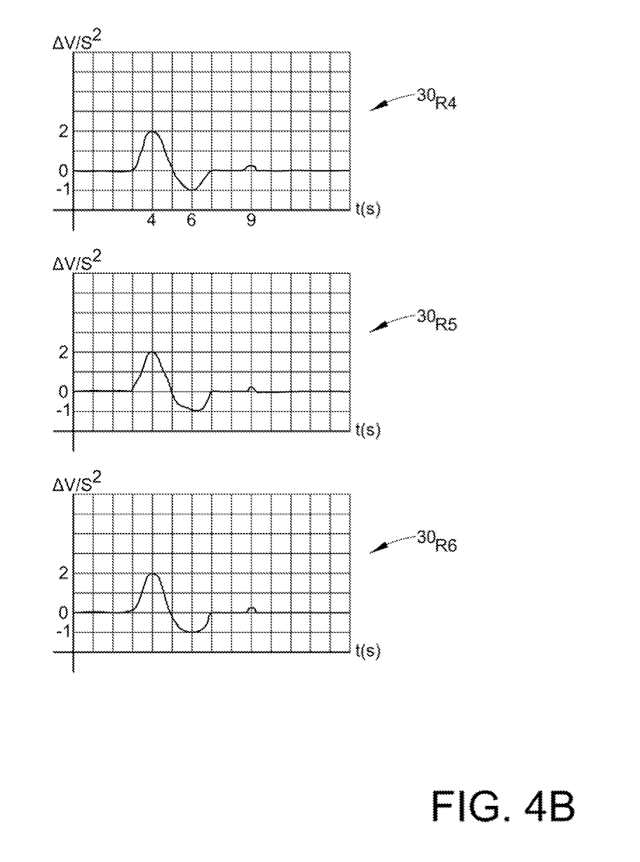

FIGS. 4a and 4b illustrate graphs 30_{B,R1-R6} showing a first physical quantity (e.g., horizontal acceleration (i.e., Δvelocity/time (Δv/t)) vs. time (t)), respectively, for each of the sensors 24_{B,R1-R6} (see FIG. 1). The horizontal acceleration is also referred to as longitudinal acceleration. Therefore, it is contemplated that in one embodiment, the sensors 24_{B,R1-R6} (see FIG. 1) are accelerometers.

With reference to FIGS. 1, 3, 4a and 4b, respective graphs 30_{B,R1-R6} are illustrated representing the signals received by the ECU 26 from the base sensor 24_{B} and the remote sensors 24_{R1-R6} that indicate horizontal acceleration of the base sensor 24_{B} and the remote sensors 24_{R1-R6}. More specifically, the signals received from the base sensor 24_{B} and illustrated as the graph 30_{B} represent acceleration of the base sensor 24_{B} and, correspondingly, the first portion (tractor) 12 of the vehicle 10. The signals received from the remote sensors 24_{R1,R2,R3} and illustrated as the graphs 30_{R1,R2,R3} represent acceleration of the remote sensors 24_{R1,R2,R3} and, correspondingly, the second portion (first trailer) 14 of the vehicle 10. The signals received from the remote sensors 24_{R4,R5,R6} and illustrated as the graphs 30_{R4,R5,R6} represent acceleration of the remote sensors 24_{R4,R5,R6} and, correspondingly, the third portion (second trailer) 16 of the vehicle 10.

A current remote sensor 24_{Cur} is identified in a step 112a as one of the remote sensors 24_{R1-R6} (e.g., the remote sensor 24_{R1}). The signals between the base sensor 24_{B} and the current remote sensor 24_{Cur} at each of the time intervals (e.g., at every 1 second) are compared in a step 112b. For example, average comparison acceleration values are determined between the base sensor 24_{B} and the current remote sensor 24_{Cur} at each of the time intervals (e.g., at each second) in the step 112b. In a step 112c, a determination is made whether a maximum time (e.g., ten (10) seconds) has been reached. If the maximum time has been reached, control passes to a step 112d for returning to the step 114. Otherwise, if the maximum time has not been reached, control passes to a step 112e, which is discussed in more detail below.

A determination of the average comparison acceleration value of the first remote sensor 24_{R1} (see graph 30_{R1} is described here. It is to be understood that the average comparison acceleration values of the other remote sensors 24_{R2-R6} (see graphs 30_{R2-R6}) are determined in a similar manner when those respective remote sensors 24_{R2-R6} (see graphs 30_{R2-R6}) are the current remote sensor. The average comparison acceleration value of the current remote sensor 24_{Cur} (e.g., the first remote sensor 24_{R1} (see graph 30_{R1})) is determined by adding absolute values of respective individual differences between the accelerations of the base sensor 24_{B} (30_{B}) and the current remote sensor 24_{Cur} (e.g., the first remote sensor 24_{R1} (30_{R1}) at predetermined time intervals (e.g., at each second) over a period of time (e.g., ten (10) seconds) before dividing that sum of the absolute values by the number of predetermined time intervals. Therefore, the average comparison acceleration value is an average of the absolute values of the acceleration differences between the base sensor 24_{B} and the current remote sensor 24_{Cur} (e.g., the first remote sensor 24_{R1}) at each of the time intervals (e.g., at each of the ten (10) one (1) second time intervals). For example, for the base sensor 24_{B} at the time of one (1) second, the acceleration is zero (0); at the time of two (2) seconds, the acceleration is zero (0); at the time of three (3) seconds, the acceleration is zero (0); at the time of four (4) seconds, the acceleration is two (2) m/s²; at the time of five (5) seconds, the acceleration is zero (0); at the time of six (6) seconds, the acceleration is −1 m/s²; at the time of seven (7) seconds, the acceleration is zero (0); at the time of eight (8) seconds, the acceleration is zero (0); at the time of nine (9) seconds, the acceleration is 0.25 m/s²; and at the time of ten (10) seconds, the acceleration is zero (0).

For the current remote sensor 24_{Cur} (e.g., the first remote sensor 24_{R1} (30_{R1})) at the time of one (1) second, the acceleration is zero (0); at the time of two (2) seconds, the acceleration is zero (0); at the time of three (3) seconds, the acceleration is zero (0); at the time of four (4) seconds, the acceleration is 1.9 m/s²; at the time of five (5) seconds, the acceleration is zero (0); at the time of six (6) seconds, the acceleration is −0.8 m/s²; at the time of seven (7) seconds, the acceleration is zero (0); at the time of eight (8) seconds, the acceleration is zero (0); at the time of nine (9) seconds, the acceleration is 0.40 m/s²; and at the time of ten (10) seconds, the acceleration is zero (0). Therefore, the average comparison acceleration value is determined as (|0 m/s²−0 m/s²|[at 1 second]+|0 m/s²−0 m/s²|[at 2 seconds]+|0 m/s²−0 m/s²|[at 3 seconds]+|2.0 m/s²−1.9 m/s²|[at 4 seconds]+|0 m/s²−0 m/s²|[at 5 seconds]+|−1.0 m/s²−(−0.8 m/s²)|[at 6 seconds]+|0 m/s²−0 m/s²|[at 7 seconds]+|0 m/s²−0 m/s²|[at 8 seconds]+|0.25 m/s²−0.4 m/s²|[at 9 seconds]+|0 m/s²−0 m/s²|[at 10 seconds])/10=0.45 m/s²/10=0.045 m/s².

As discussed below, during a subsequent iteration (e.g., when the second remote sensor 24_{R2} (30_{R2}) is the current remote sensor 24_{Cur}), similar calculations are performed for the base sensor 24_{B} (30_{B}) and the second remote sensor 24_{R2} (30_{R2}). The second remote sensor 24_{R2} (30_{R2}) includes accelerations of 2.4 m/s² at 4 seconds, −0.6 m/s² at 6 seconds, and 0.25 m/s² at 9 seconds. Zero (0) acceleration is assumed at the other times of 1-3, 5, 7, 8, and 10 seconds. Therefore, the average comparison acceleration value for the base sensor 24_{B} (30_{B}) and the second remote sensor 24_{R2} (30_{R2}) is determined as (|0 m/s²−0 m/s²|[at 1 second]+|0 m/s²−0 m/s²|[at 2 seconds]+|0 m/s²−0 m/s²|[at 3 seconds]+|2.0 m/s²−2.4 m/s²|[at 4 seconds]+|0 m/s²−0 m/s²|[at 5 seconds]+|−1.0 m/s²−(−0.6 m/s²)|[at 6 seconds]+|0 m/s²−0 m/s²|[at 7 seconds]+|0 m/s²−0 m/s²|[at 8 seconds]+|0.25 m/s²−0.25 m/s²|[at 9 seconds]+|0 m/s²−0 m/s²|[at 10 seconds])/10=0.08 m/s².

As discussed below, during a subsequent iteration (e.g., when the third remote sensor 24_{R3} (30_{R3}) is the current remote sensor 24_{Cur}), similar calculations are performed for the base sensor 24_{B} (30_{B}) and the third remote sensor 24_{R3} (30_{R3}). The third remote sensor 24_{R3} (30_{R3}) includes accelerations of 2.0 m/s² at 4 seconds, −0.9 m/s² at 6 seconds, and 0.4 m/s² at 9 seconds. Zero (0) acceleration is assumed at the other times of 1-3, 5, 7, 8, and 10 seconds. Therefore, the average comparison acceleration value for the base sensor 24_{B} (30_{B}) and the third remote sensor 24_{R3} (30_{R3}) is determined as (|0 m/s²−0 m/s²|[at 1 second]+|0 m/s²−0 m/s²|[at 2 seconds]+|0 m/s²−0 m/s²|[at 3 seconds]+|2.0 m/s²−2.0 m/s²|[at 4 seconds]+|0 m/s²−0 m/s²|[at 5 seconds]+|−1.0 m/s²−(−0.9 m/s²)|[at 6 seconds]+|0 m/s²−0 m/s²|[at 7 seconds]+|0 m/s²−0 m/s²|[at 8 seconds]+|0.25 m/s²−0.4 m/s²|[at 9 seconds]+|0 m/s²−0 m/s²|[at 10 seconds])/10=0.025 m/s².

As discussed below, during a subsequent iteration (e.g., when the fourth remote sensor 24_{R4} (30_{R4}) is the current remote sensor 24_{Cur}), similar calculations are performed for the base sensor 24_{B} (30_{B}) and the fourth remote sensor 24_{R4} (30_{R4}). The fourth remote sensor 24_{R4} (30_{R4}) includes accelerations of 2.0 m/s² at 4 seconds, −1.0 m/s² at 6 seconds, and 0.25 m/s² at 9 seconds. Zero (0) acceleration is assumed at the other times of 1-3, 5, 7, 8, and 10 seconds. Therefore, the average comparison acceleration value for the base sensor 24_{B} (30_{B}) and the fourth remote sensor 24_{R4} (30_{R4}) is determined as (|0 m/s²−0 m/s²|[at 1 second]+|0 m/s²−0 m/s²|[at 2 seconds]+|0 m/s²−0 m/s²|[at 3 seconds]+|2.0 m/s²−2.0 m/s²|[at 4 seconds]+|0 m/s²−0 m/s²|[at 5 seconds]+|−1.0 m/s²−(−1.0 m/s²)|[at 6 seconds]+|0 m/s²−0 m/s²|[at 7 seconds]+|0 m/s²−0 m/s²|[at 8 seconds]+|0.25 m/s²−0.25 m/s²|[at 9 seconds]+|0 m/s²−0 m/s²|[at 10 seconds])/10=0 m/s².

As discussed below, during a subsequent iteration (e.g., when the fifth remote sensor 24_{R5} (30_{R5}) is the current remote sensor 24_{Cur}), similar calculations are performed for the base sensor 24_{B} (30_{B}) and the fifth remote sensor 24_{R5} (30_{R5}). The fifth remote sensor 24_{R5} (30_{R5}) includes accelerations of 2.0 m/s² at 4 seconds, −1.0 m/s² at 6 seconds, and 0.25 m/s² at 9 seconds. Zero (0) acceleration is assumed at the other times of 1-3, 5, 7, 8, and 10 seconds. Therefore, the average comparison acceleration value for the base sensor 24_{B} (30_{B}) and the fifth remote sensor 24_{R5} (30_{R5}) is determined as (10 m/s²−0 m/s²|[at 1 second]+|0 m/s²−0 m/s²|[at 2 seconds]+|0 m/s²−0 m/s²|[at 3 seconds]+|2.0 m/s²−2.0 m/s²|[at 4 seconds]+|0 m/s²−0 m/s²|[at 5 seconds]+|−1.0 m/s²−(−1.0 m/s²)|[at 6 seconds]+(0 m/s²−0 m/s²)[at 7 seconds]+(0 m/s²−0 m/s²)[at 8 seconds]+(0.25 m/s²−0.25 m/s²)[at 9 seconds]+(0 m/s²−0 m/s²)[at 10 seconds])/10=0 m/s².

As discussed below, during a subsequent iteration (e.g., when the sixth remote sensor 24_{R6} (30_{R6}) is the current remote sensor 24_{Cur}), similar calculations are performed for the base sensor 24_{B} (30_{B}) and the sixth remote sensor 24_{R6} (30_{R6}). The sixth remote sensor 24_{R6} (30_{R6}) includes accelerations of 2.0 m/s² at 4 seconds, −1.0 m/s² at 6 seconds, and 0.25 m/s² at 9 seconds. Zero (0) acceleration is assumed at the other times of 1-3, 5, 7, 8, and 10 seconds. Therefore, the average comparison acceleration value for the base sensor 24_{B} (30_{B}) and the sixth remote sensor 24_{R6} (30_{R6}) is determined as (|0 m/s²−0 m/s²|[at 1 second]+|0 m/s²−0 m/s²|[at 2 seconds]+|0 m/s²−0 m/s²|[at 3 seconds]+|2.0 m/s²−2.0 m/s²|[at 4 seconds]+|0 m/s²−0 m/s²|[at 5 seconds]+|−1.0 m/s²−(−1.0 m/s²)|[at 6 seconds]+(0 m/s²−0 m/s²)[at 7 seconds]+(0 m/s²−0 m/s²)[at 8 seconds]+(0.25 m/s²−0.25 m/s²)[at 9 seconds]+(0 m/s²−0 m/s²)[at 10 seconds])/10=0 m/s².

For the purposes of discussion, it is assumed again that the first remote sensor 24_{R1} (30_{R1}) is the current remote sensor 24_{Cur}.

In the step 112e, a determination is made whether the average comparison acceleration value is less than a predetermined average comparison threshold value (e.g., 1 m/s²). If the average comparison acceleration value is less than the predetermined average comparison threshold, control passes to a step 112f for associating the current remote sensor 24_{Curr} with the ECU 26. A determination is then made in a step 112g if additional remote sensors 24_{R2-R6} have not yet been evaluated. If any of the remote sensors 24_{R2-R6} has not yet been evaluated, the next remote sensor 24_{R2-R6} is set as the current remote sensor 24_{Curr} in a step 112h. Control then returns to the step 112b. If, on the other hand, all of the remote sensors 24_{R2-R6} have been evaluated, control passes to the step 112d for returning to the step 114.

If, in the step 112e, the average comparison acceleration value is not less than the predetermined average comparison threshold, control passes to a step 112i for indicating that the current remote sensor 24_{Curr} should not be associated with the ECU 26. Control then passes to the step 112g to determine if any additional remote sensors 24_{R2-R6} have not yet been evaluated.

The methodology described above provides one opportunity for deciding whether to associate (e.g., couple) the remote sensor(s) 24_{R1-R6} with the ECU 26. Perhaps, because of noise caused by one or more of the remote sensor(s) 24_{R1-R6} is hanging on a loose and/or vibrating part of the vehicle, one or more of the remote sensor(s) 24_{R1-R6} will not properly couple with the ECU 26. It is contemplated that such issues can be addressed by smaller (e.g., finer) predetermined time intervals. More specifically, instead of using predetermined time intervals of one (1) second during the time period of ten (10) seconds, smaller (e.g., finer) predetermined time intervals (e.g., 0.1 second) may be used. If at least a predetermined number of the respective average comparison acceleration values of the ten (10) respective 0.1 second intervals of each second are less than a predetermined average finer threshold value (e.g., 1 m/s²), the second associated with the ten (10) 0.1 second intervals is considered in the step 112e as having a comparison acceleration value less than the predetermined average comparison threshold. On the other hand, if at least a predetermined number of the respective average comparison acceleration values of the ten (10) respective 0.1 second intervals of each second are not less than the predetermined average finer threshold value, the second associated with the ten (10) 0.1 second intervals is considered in the step 112e as not having a comparison acceleration value less than the predetermined individual comparison threshold.

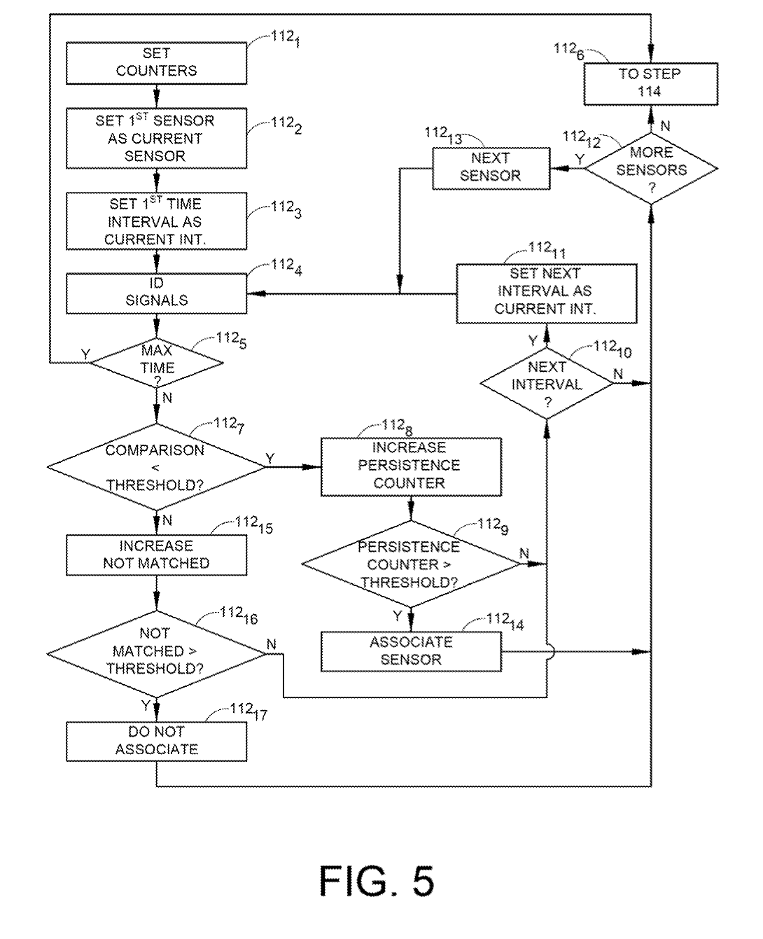

FIG. 5 illustrates a second embodiment of an exemplary methodology of the step 112 for associating the remote sensors 24_{R1-R6} (and their associated cameras 22_{R1-R6}) (see FIG. 1) with the ECU 26 (see FIG. 1) (e.g., with the tractor 12 of the vehicle 10). As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1, 4a and 4b and 5, counters are set in a step 112₁. More specifically, a persistence counter and a “not matched” counter are both set to zero (0) in the step 112₁. A current remote sensor 24_{Cur} is identified in a step 112₂ as one of the remote sensors 24_{R1-R6} (e.g., the remote sensor 24_{R1}). A current time interval is set as one of the time intervals (e.g., the first time interval at one (1) second) in a step 112₃. The signals between the base sensor 24_{B} and the current remote sensor 24_{Cur} at the current time interval is identified in a step 112₄. In a step 112₅, a determination is made whether a maximum time (e.g., ten (10) seconds) has been reached. If the maximum time has been reached, control passes to a step 112₆ for returning to the step 114. Otherwise, if the maximum time has not been reached, control passes to a step 112₇.

In the step 112₇, a determination is made whether an individual comparison acceleration value for the current time interval (e.g., |0 m/s²−0 m/s²|[at 1 second] when the current remote sensor 24_{Cur} is the first remote sensor 24_{R1}) is less than a predetermined individual comparison threshold value (e.g., 1 m/s²). If the individual comparison acceleration value is less than the predetermined individual comparison threshold, control passes to a step 112₈ for increasing the persistence counter by, for example, one (1). A determination is then made in a step 112₉ whether the persistence counter is greater than a persistence counter threshold (e.g., seven (7), which would represent 70% if there are ten (10) time intervals). If the persistence counter is not greater than the persistence counter threshold, control passes to a step 112₁₀ for determining if a next time interval is available to evaluate. If a next time interval is available, control passes to a step 112₁₁ for setting the current time interval to the next time interval (e.g., to the second time interval) before returning to the step 112₄. Otherwise, if all of the time intervals for the current sensor 24_{Cur} have been evaluated, control passes to a step 112₁₂ for determining if all of the remote sensors 24_{R1-R6} have been evaluated. If all of the remote sensors 24_{R1-R6} have not yet been evaluated, control passes to a step 112₁₃ for setting the a next one of the remote sensors 24_{R1-R6} as the current sensor 24_{Curr}. Otherwise, if all of the remote sensors 24_{R1-R6} have been evaluated, control passes to the step 112₆.

If it is determined in the step 112₉ that the persistence counter is greater than the persistence counter threshold, the current remote sensor 24_{Curr} is associated with the ECU 26 in a step 112₁₄. before passing to the step 112₁₂ to determine if additional sensors are available to evaluate.

If it is determined in the step 112₇ that the individual comparison acceleration value for the current time interval is not less than a predetermined individual comparison threshold value, control passes to a step 112₁₅ to increase the “not matched” counter by, for example, one (1). A decision is then made in a step 112₁₆ whether the “not matched” counter is greater than a “not matched” counter threshold (e.g., seven (7)). If the “not matched” counter is not greater than the “not matched” counter threshold, control passes to the step 112₁₀ for determining if additional time intervals are available. Otherwise, if the “not matched” counter is greater than the “not matched” counter threshold, a decision is made in a step 112₁₇ to not associate the remote sensors 24_{R1-R6} with the ECU 26 before passing to the step 112₁₂ for determining if additional remote sensors 24_{R1-R6} are available.

The methodology described above provides one opportunity for deciding whether to associate (e.g., couple) the remote sensor(s) 24_{R1-R6} with the ECU 26. Perhaps, because of noise caused by one or more of the remote sensor(s) 24_{R1-R6} is hanging on a loose and/or vibrating part of the vehicle, one or more of the remote sensor(s) 24_{R1-R6} will not properly couple with the ECU 26. It is contemplated that such issues can be addressed by smaller (e.g., finer) predetermined time intervals. More specifically, instead of using predetermined time intervals of one (1) second during the time period of ten (10) seconds, smaller (e.g., finer) predetermined time intervals (e.g., 0.1 second) may be used. If at least a predetermined number of the respective individual comparison acceleration values of the ten (10) respective 0.1 second intervals of each second are less than a predetermined individual finer threshold value (e.g., 1 m/s²), the second associated with the ten (10) 0.1 second intervals is considered in the step 112₇ as having a comparison acceleration value less than the predetermined individual comparison threshold. On the other hand, if at least a predetermined number of the respective individual comparison acceleration values of the ten (10) respective 0.1 second intervals of each second are not less than the predetermined individual finer threshold value, the second associated with the ten (10) 0.1 second intervals is considered in the step 112₇ as not having a comparison acceleration value less than the predetermined individual comparison threshold.

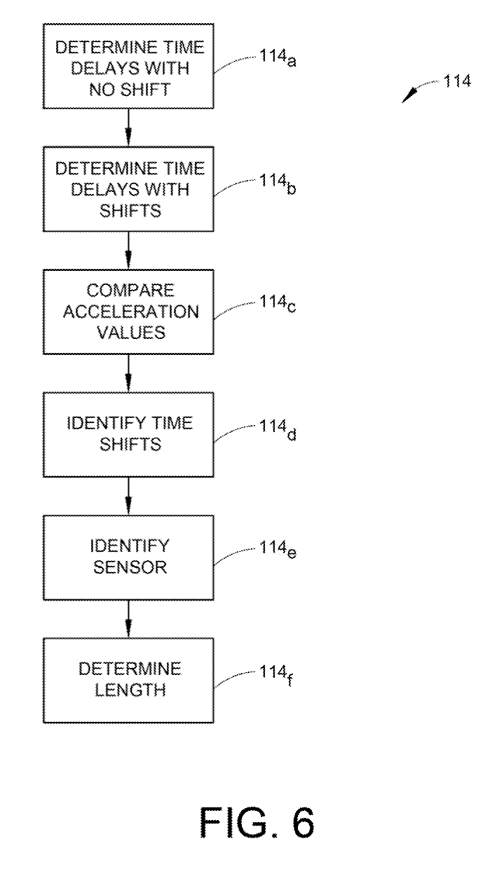

FIG. 6 illustrates an exemplary methodology of the step 114 for determining respective distances between the base sensor 24_{B} (see FIG. 1) and the remote sensors 24_{R3,R6} (see FIG. 1). The distances between the base sensor 24_{B} and the remote sensors 24_{R3,R6} is selected because the remote sensors 24_{R3,R6} are located at the rear of the respective vehicle portions 14, 16 (see FIG. 1). As illustrated, the blocks represent functions, actions and/or events performed therein. It will be appreciated that electronic and software systems involve dynamic and flexible processes such that the illustrated blocks and described sequences can be performed in different sequences. It will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

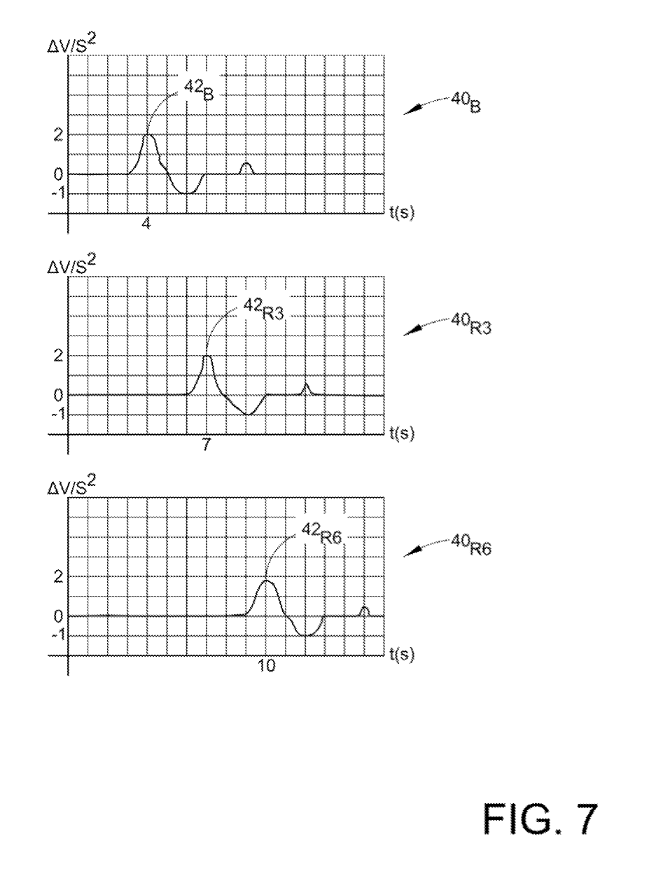

FIG. 7 illustrates graphs 40_{B,R3,R6} showing a second physical quantity (e.g., vertical acceleration (i.e., Δvelocity/time (Δv/t)) vs. time (t)), respectively, for each of the base sensor 24_{B} on the tractor 12, the remote sensor 24₃ on the first trailer 14, and the remote sensors 24₆ on the second trailer 16. Vertical acceleration typically changes when the vehicle 10 goes over a bump or hill on the road surface. Because of the vehicle length, the tractor 12 will typically go over the bump first, then the first trailer portion 14 will go over the same bump, and lastly the second trailer portion 16 will go over the bump. Therefore, there is a time delay between when the various vehicle portions 12, 14, 16 go over the bump. Because of the time delays when the various vehicle portions 12, 14, 16 go over the bump, similar time delays are also evident in the vertical accelerations of the various vehicle portions 12, 14, 16. The lengths of the time delays are assume to be a function of the respective distance between the base sensor 24_{B} and the remote sensors 24_{R1-R6}.

With reference to FIGS. 1, 6, and 7, the graphs 40_{B,R3,R6} show time delays between the peaks 42_{B,R3,R6} for analogous signals. The ECU 26 determines the time delay (e.g., shift) between the graphs by determining acceleration values for each of the graphs in a step 114a with no time shift. For example, the ECU 26 determines the acceleration value between the graphs 40_{B,R3} by multiplying the acceleration of the graph 40_{B} by the acceleration of the graph 40_{R3} at specific increments (e.g., each millisecond) over a period of time (e.g., 15 milliseconds).

The acceleration value between the graphs 40_{B,R3} is (0*0)+(0*0)+(0*0)+(2*0)+(0*0)+(−1*0)+(0*2)+(0*0)+(0.5*−1)+(0*0)+(0*0)+(0*0.5)+(0*0)+(0*0)+(0*0)+(0*0)=−0.5.

In a step 114b, the ECU 26 determines the time delay (e.g., shift) between the graphs by determining acceleration values for each of the graphs with time shifts. For example, if the graph 40_{R3} is time shifted 3 ms earlier (e.g., to the left), the acceleration value between the graphs 40_{B,R3} becomes (0*0)+(0*0)+(0*0)+(2*2)+(0*0)+(−1*−1)+(0*0)+(0*0)+(0.5*0.5)+(0*0)+(0*0)+(0*0)+(0*0)+(0*0)+(0*0)+(0*0)=5.25. It becomes clear that the largest acceleration value results when the graphs are time shifted to create a best overlap. As camera signals are typically sent less frequently than accelerations are measured, multiple accelerations, taken at different time instants within the camera sending interval, may be transmitted with the camera signal. The finer temporal resolution on the acceleration signals enables a finer measurement of the distance between the camera sensors. For example, camera images may be transmitted every 30 milliseconds, while acceleration may be measured every millisecond. Therefore, 30 acceleration values may be acquired and then transmitted for each camera image. Association may be established after some predetermined number (e.g., 100) of acceleration values match each other. If a number (e.g., greater than a predetermined threshold) of acceleration values persistently disagree, a timeout condition is reached and no association is established. As a consequence, the camera is not associated with the ECU (e.g., not added to the network). To summarize, persistently similar significant acceleration values (e.g., within a predetermined threshold number) lead to association and persistently different, but significant acceleration values lead to non-association.

In a step 114c, the ECU 26 compares the acceleration values between the graphs 40_{B,R3} for both the non-time shifted and time shifted. In a step 114d, the ECU 26 identifies the time shifts associated with the largest acceleration values. For example, it is clear that the largest acceleration values occur if the graph 40_{R3} is shifted 3 ms earlier (e.g., to the left) and if the graph 40_{R6} is shifted 6 ms earlier (e.g., to the left). More specifically, if the 40_{R3} is shifted 3 ms earlier (e.g., to the left) and if the graph 40_{R6} is shifted 6 ms earlier (e.g., to the left), the graphs 40_{B,R3,R6} will be substantially aligned.

In a step 114e, the ECU 26 identifies the sensor associated with the largest time shift, which will be used for determining the longest distance from the base sensor 24_{B}. The longest distance from the base sensor 24_{B} is assumed to represent the distance from the base sensor 24_{B} to the rear of the vehicle 10. It is assumed the ECU 26 has been previously programmed with the distance from the base sensor 24_{B} to the front of the vehicle 10. In the present example, the largest time shift of 6 ms is associated with the remote sensor 24₆. The total length of the vehicle 10 is then determined by adding the longest distance from the base sensor 24_{B} and the distance from the base sensor 24_{B} to the front of the vehicle 10.

Then, in a step 114f, the ECU 26 determines the length from the base sensor 24_{B} to the farthest sensor, which in the present example is the sensor 24₆. It is assumed the ECU 26 can obtain the speed of the vehicle 10. Therefore, the ECU 26 determine the distance to the farthest sensor 24₆ by multiplying the velocity of the vehicle 10, which is units of distance per time, by the time of the delay between the base sensor 24_{B} and the farthest sensor 24₆, which results in a product having the units of distance.

The process described above sets forth how the electronic control unit 26 determines the distance between the base sensor 24_{B} and the remote sensor (e.g., farther remote sensor 24₆) based on respective signals received from the base sensor 24_{B} and the remote sensor 24₆ representing respective measurements of a second physical quantity (vertical acceleration) by the base sensor 24_{B} and the remote sensor 24₆.

In the embodiments described above, it is to be understood that the ECU 26 includes circuitry that acts as a means for receiving base signals from the base sensor 24_{B} on the towing portion 12 of the vehicle 10. The ECU 26 also includes circuitry that acts as a means for receiving remote signals from the remote sensors 24_{R1-R6} on the towed portions 14, 16 of the vehicle 10. The ECU 26 also includes circuitry that acts as a means for associating the remote sensors 24_{R1-R6} with the base sensor 24_{B} based on respective signals received from the base sensor 24_{B} and the remote sensors 24_{R1-R6} representing respective measurements of a first physical quantity (e.g., horizontal acceleration) by the base sensor 24_{B} and the remote sensors 24_{R1-R6.} The ECU 26 also includes circuitry that acts as a means for comparing the signals received from the base unit 24_{B} (e.g., base sensor) representing the measurement of the first physical quantity of the towing portion 12 of the vehicle 10 over a time period with the signals received from the remote units 24_{R1-R6} (e.g., remote sensors) representing the measurement of the first physical quantity of the towed portion 12 of the vehicle 10 over the time period. The ECU 26 also includes circuitry that acts as a means for associating the remote sensors 24_{R1-R6} with the base sensor 24_{B} based on the comparison of the signals received from the base unit 24_{B} with the signals received from the remote unit 24_{R1-R6} over the time period. The ECU 26 also includes circuitry that acts as a means for determining a distance between the base sensor 24_{B} and the remote sensors 24_{R1-R6} based on respective signals received from the base sensor 24_{B} and the remote sensors 24_{R1-R6} representing respective measurements of vertical accelerations of the base sensor 24_{B} and the remote sensors 24_{R1-R6}.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A camera system on a vehicle, comprising:
an electronic control unit;
a base sensor, on a first portion of the vehicle, communicating with the electronic control unit; and
a remote sensor, on a second portion of the vehicle, communicating with the electronic control unit, the electronic control unit determining a distance between the base sensor and the remote sensor based on respective signals received from the base sensor and the remote sensor representing respective measurements of a vertical physical quantity by the base sensor and the remote sensor.

2. The camera system as set forth in claim 1, wherein:
the electronic control unit compares the signals received from the base unit representing the measurement of the vertical physical quantity of the first portion of the vehicle over a time period with the signals received from the remote unit representing the measurement of the vertical physical quantity of the second portion of the vehicle over the time period.

3. The camera system as set forth in claim 2, wherein:
the vertical physical quantity is vertical acceleration;
the signals received by the electronic control unit from the base sensor represent the measurement by the base sensor of the vertical acceleration of the first portion of the vehicle; and
the signals received by the electronic control unit from the remote sensor represent the measurement by the remote sensor of the vertical acceleration of the second portion of the vehicle.

4. The camera system as set forth in claim 3, wherein:
the electronic control unit determines a distance between the base sensor and the remote sensor based on a time shift between an analogous one of the signals representing the measurement of the vertical acceleration of the first portion of the vehicle and the signals representing the measurement of the vertical acceleration of the second portion of the vehicle.

5. The camera system as set forth in claim 3, wherein:
a horizontal physical quantity is longitudinal acceleration;
the signals received by the electronic control unit from the base sensor also represent the measurement by the base sensor of the longitudinal acceleration of the first portion of the vehicle; and
the signals received by the electronic control unit from the remote sensor also represent the measurement by the remote sensor of the longitudinal acceleration of the second portion of the vehicle.

6. The camera system as set forth in claim 1, wherein:
at least one of the base sensor and the remote sensor wirelessly communicates with the electronic control unit.

7. The camera system as set forth in claim 1, wherein:
the base sensor is an accelerometer; and
the remote sensor is an accelerometer.

8. An electronic control unit used in a camera system, the electronic control unit comprising:
means for receiving base signals from a base unit on a towing portion of a vehicle, the base signals representing measurements of a vertical physical quantity by the base unit;
means for receiving remote signals from a remote unit on a towed portion of the vehicle, the remote signals representing measurements of the vertical physical quantity by the remote unit; and
means for determining a distance between the base unit and the remote unit based on the respective signals received from the base unit and the remote unit representing the vertical accelerations of the base unit and the remote unit.

9. A method for determining a distance between a base camera on a towing portion of a vehicle and a remote camera on a towed portion of the vehicle, the method comprising:
receiving base signals from a base sensor, on the towing portion of the vehicle, representing a measurement of a vertical physical quantity of the towing portion of the vehicle;
receiving remote signals from a remote sensor, on the towed portion of the vehicle, representing a measurement of the vertical physical quantity of the towed portion of the vehicle;
comparing the base signals with the remote signals; and
determining a distance between the base sensor and the remote sensor based on respective signals received from the base sensor and the remote sensor representing respective measurements of the vertical physical quantity by the base sensor and the remote sensor.

10. The method for associating a base camera with a remote camera as set forth in claim 9, further including:
determining acceleration values between the base sensor and the remote sensor.

11. The method for associating a base camera with a remote camera as set forth in claim 10, further including:
determining a time shift between the base sensor and the remote sensor based on a largest of the acceleration values.

12. The method for associating a base camera with a remote camera as set forth in claim 11, further including:
determining the distance between the base sensor and the remote sensor based on the time shift.

13. The method for associating a base camera with a remote camera as set forth in claim 12, further including:
determining the distance between the base sensor and the remote sensor based on a speed of the towing portion and the towed portion.

14. The method for associating a base camera with a remote camera as set forth in claim 9, further including:
comparing the signals received from the base unit representing the measurement of the vertical physical quantity of the towing portion of the vehicle over a time period with the signals received from the remote unit representing the measurement of the vertical physical quantity of the towed portion of the vehicle over the time period.

15. The method for associating a base camera with a remote camera as set forth in claim 14, further including:
determining the distance between the base sensor and the remote sensor based on a time shift between an analogous one of the signals representing the vertical physical quantity of the vertical acceleration of the towing portion of the vehicle and the signals representing the measurement of the vertical physical quantity of the towed portion of the vehicle.

16. The method for associating a base camera with a remote camera as set forth in claim 9, further including:
determining a vertical acceleration of the towing portion of the vehicle based on the measurement of the vertical physical quantity of the towing portion of the vehicle; and
determining a vertical acceleration of the towed portion of the vehicle based on the measurement of the vertical physical quantity of the towed portion of the vehicle.

17. A system for determining a length of an articulated vehicle, the system comprising:
an electronic control unit on a towing portion of the vehicle;
a base sensor on the towing portion of the vehicle and communicating with the electronic control unit, the base sensor sensing a vertical acceleration of the towing portion and transmitting base vertical signals representing the vertical acceleration of the towing portion; and
a remote sensor on a towed portion of the vehicle and wirelessly communicating with the electronic control unit, the remote sensor sensing a vertical acceleration of the towed portion of the vehicle and transmitting remote vertical signals representing the vertical acceleration of the towed portion, the electronic control unit receiving the base signals and the remote signals and a distance between a front end of the towing portion and a rear end of the towed portion based on the base vertical signals and the remote vertical signals.
